(19) United States
(12) Patent Application Publication
(10) Pub. No.: US 2008/0155259 A1
(43) Pub. Date: Jun. 26, 2008

(54) COMPUTER READABLE MEDIUM STORING ELECTRONIC DOCUMENT PROCESSING PROGRAM, ELECTRONIC DOCUMENT PROCESSING SYSTEM, KEY INFORMATION RECORDING SYSTEM, DOCUMENT STORAGE SYSTEM AND ELECTRONIC DOCUMENT PROCESSING METHOD

(75) Inventor: Hiroyuki KANEKO, Kawasaki-shi (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 11/774,638

(22) Filed: Jul. 9, 2007

(30) Foreign Application Priority Data
Dec. 25, 2006 (JP) 2006-347127

(51) Int. Cl. H04L 9/00

(52) U.S. Cl. 713/168

(57) ABSTRACT

An electronic document processing method includes: storing, in a storage section, (i) a document identifier for uniquely identify each electronic document and (ii) key information of a storage of a non-electronic document which relates to each electronic document in association with each other; receiving a request for acquisition of key information which is associated with a specified electronic document; and detecting the requested key information stored in the storage section in response to the received request.

### CROSS-REFERENCE TO RELATED APPLICATIONS

This application is based on and claims priority under 35 U.S.C. §119 from Japanese Patent Application No. 2006-347127 Dec. 25, 2006.

### BACKGROUND

1. Technical Field

The invention relates to an electronic document processing program, a key information record program, an electronic document processing system, a key information recording system, a document storage system, an electronic document processing method, a key information recording method and a computer readable medium storing any of the programs.

2. Related Art

In activities in enterprises, a job process is advanced mainly using electronic documents as IT (Information Technology) progresses.

On the other hand, in regulation management of enterprise activities, it is necessary that audit (internal audit or external audit) is conducted with paying attention to one audit trail, according to the audit policy. A contract, a business form, etc., exists as the audit trail and the documents must often be stored as paper documents from the viewpoint of regulation management.

In other words, it is required to manage electronic documents and paper documents that can become the audit trail of the electronic documents in association with each other.

In a general job process, it is also required to integrally manage electronic documents and paper documents corresponding to the electronic documents.

### SUMMARY

According to an aspect of the invention, a computer readable medium stores a program causing a computer to execute electronic document processing. The electronic document processing includes: storing, in a storage section, (i) a document identifier for uniquely identify each electronic document and (ii) key information of a storage of a non-electronic document which relates to each electronic document, in association with each other; receiving a request for acquisition of key information which is associated with a specified electronic document; and detecting the requested key information stored in the storage section in response to the received request.

### BRIEF DESCRIPTION OF THE DRAWINGS

Exemplary embodiments of the invention will be described below with reference to the accompanying drawings in detail, wherein:

FIG. 1 is a block diagram of the conceptual module configuration of a first exemplary embodiment of the invention;

FIG. 2 is a module configuration diagram to describe a configuration example of a system according to the first exemplary embodiment of the invention;

FIG. 3 is a schematic representation to show a document processing example of the system according to the first exemplary embodiment of the invention;

FIG. 4 is a flowchart to describe an example of document processing executed by the system according to the first exemplary embodiment of the invention;

FIG. 5 is a schematic representation to show data structure examples of a document attribute table, a document access right table, and an original storage location key data table; and

FIG. 6 is a block diagram to show a hardware configuration example of a computer for implementing first and second exemplary embodiments of the invention.

### DETAILED DESCRIPTION

Referring now to the accompanying drawings, exemplary embodiments of the invention will be described.

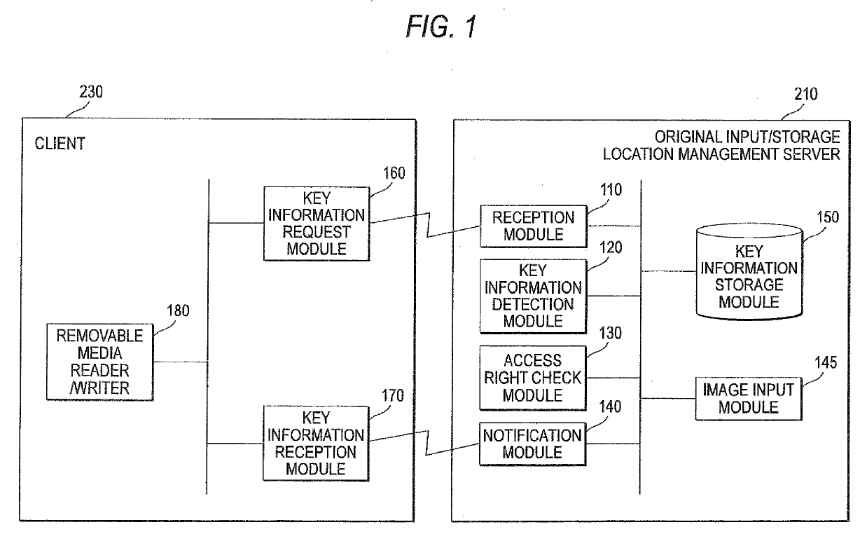

FIG. 1 shows a conceptual module configuration example of the first exemplary embodiment of the invention.

A module refers generally to a logically detachable software component or hardware component. Therefore, the module in the exemplary embodiment means not only a module in a program, but also a module in the hardware configuration. Therefore, the exemplary embodiments also serve as the description of a program, a computer readable medium storing the program, a system and a method. Modules are almost in a one-to-one correspondence with functions. However, in implementation, one module may be one program; two or more modules may make up one program; or two or more programs may make up one module. Two or more modules may be executed by one computer or one module may be executed in two or more computers in a distributed or parallel environment. In the following description, the term “connection” contains not only physical connection, but also logical connection (data transfer, command, instruction, etc.,).

The system is not only provided by connecting plural computers, hardware components, apparatus, etc., through a network, etc., but also implemented as one computer, hardware, apparatus, etc

The exemplary embodiments provide a system that can manage non-electronic documents corresponding to electronic documents in a unified manner. The “non-electronic document” refers to a paper document, etc., based on the electronic document or a paper document, etc., on which the electronic document is based. The paper documents, etc., include a document formed on a paper, a microfilm, a video film, etc., for example. The paper documents are those that can be physically stored and include not only an original, but also an authenticated copy of the original, an attested copy of the original, a certified extract copy of the original and a copy of the original. The electronic documents contain text information, image information, moving image information, audio information, etc. and electronic information containing different types of information (for example, electronic information containing text information and image information). For example, an electronic document is printed to create a non-electronic document. Also, a non-electronic document is read through a scanner to create an electronic document. In the following description, the case where a paper document serving as a non-electronic document is an original will be described.

The storage device for paper documents is one that can be locked with electronic key information. For example, the storage device may be any of a cabinet, a closet, a retention vessel, a chest, a desk drawer, a locker, a cash box, a library, a hangar, a repository, a building, etc.

“Access” refers to reading or writing data from or into a storage (containing memory; it is not necessarily limited to an internal storage of a computer) using the computer. An “access right” refers to a right for a user to manipulate an electronic document. For example, the access right may include a write right for a user to write into an electronic document, a read right for a user to read an electronic document, etc. Here, if a user can access an electronic document (with a display right), the user is said to have the access right.

The system of this exemplary embodiment includes an original input/storage location management server 210 and a client 230 are connected via a communication line as shown in FIG. 1. The original input/storage location management server 210 includes a reception module 110, a key information detection module 120, an access right check module 130, a notification module 140, an image input module 145 and a key information storage module 150. The client 230 includes a key information request module 160, a key information reception module 170, and a removable media reader/writer 180. The modules in the client 230 and the modules in the original input/storage location management server 210 are connected.

The reception module 110 receives a request transmitted from the key information request module 160 of the client 230. The request is a request for acquisition of key information relating to a storage location of a paper document corresponding to a specified electronic document.

The key information detection module 120 detects the requested key information stored in the key information storage module 150 in response to the request received by the reception module 110. If a requesting party who makes the request received by the reception module 110 (here, the client 230, a user of the client 230, or the like) does not have an access right for the electronic document, the key information detection module 120 may control so as not to output the detected key information. If the requesting party who makes the request received by the reception module 110 has the access right for the electronic document, the key information detection module 120 controls so as to output the detected key information.

The access right check module 130 checks the access right for the electronic document in the request, in response to the request received by the reception module 110. The access right check module 130 passes the check result to the key information detection module 120.

The notification module 140 sends the key information relating to the storage location of the paper document to the requesting party who sends the request to the reception module 110.

The image input module 145 reads a paper document through a scanner, etc., and converts the paper document into an electronic document.

The key information storage module 150 stores a document identifier for uniquely identifying each electronic document and the key information relating to the storage location of the paper document corresponding to each electronic document in association with each other. The key information storage module 150 may further store a name, an address, etc., of the storage location of each paper document.

The key information request module 160 transmits a request for acquisition of key information to the reception module 110 of the original input/storage location management server 210. The request may contain a document identifier for uniquely identifying an electronic document (which may be a file name, etc.,). The key information relates to the storage location of a paper document corresponding to the electronic document. For example, the key information may be electronic information to unlock an electronic lock provided with the storage location of the paper document.

The key information reception module 170 receives the key information transmitted by the notification module 140 of the original input/storage location management server 210. The received key information corresponds to the request transmitted by the key information request module 160.

The removable media reader/writer 180 records the key information received by the key information reception module 170, into a removable medium. Here, the “removal medium” refers to a portable recording medium such as a USB (Universal Serial Bus) token.

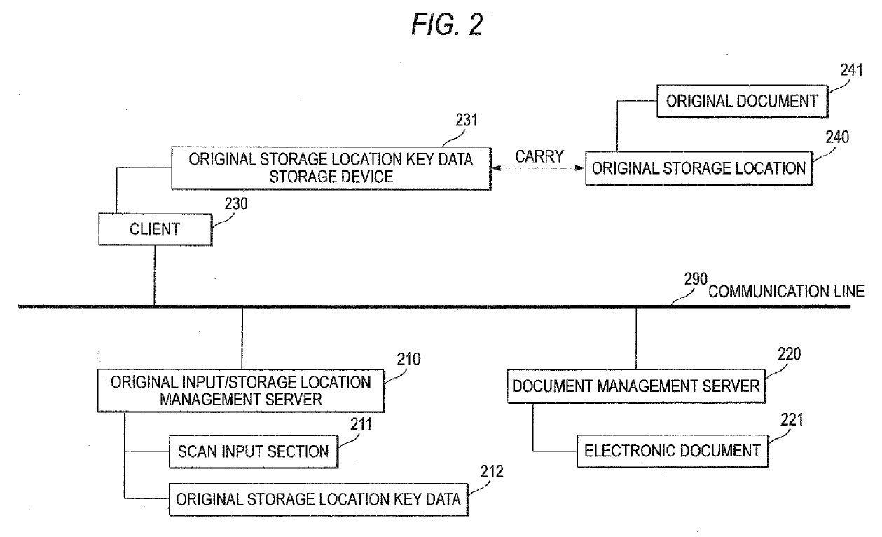

A general configuration example of this system will be described with reference to FIG. 2.

The client 230, the original input/storage location management server 210, and a document management server 220 are connected via a communication line 290.

The original input/storage location management server 210 is a server for managing scan input of a paper document serving as an original and key data of the storage location of the original.

A scan input section 211 and key data original storage location key data 212 are connected in the original input/storage location management server 210 as shown in FIG. 2. The scan input section 211 is a scanner controlled by the image input module 145 shown in FIG. 1. The scan input section 210 reads a paper document and converts the paper document into an electronic document. The electronic document is passed to the document management server 220 through the communication line 290 and is stored in an electronic document database (not shown) in the document management server 220. The original storage location key data 212 is stored in the key information storage module 150 shown in FIG. 1 and is data indicating a storage location of each paper document.

The document management server 220 is a server (DMS: Document Management System) for managing the electronic documents sent from the original input/storage location management server 210.

In the document management server 220, an electronic document 221 is managed by the electronic document database. The electronic documents sent from the original input/storage location management server 210 (namely, electronic documents read through the scan input section 211) are image data.

The client 230 is a client for browsing the electronic documents stored in the document management server 220 and downloading the original storage location key data 212 managed by the original input/storage location management server 210 to an original storage location key data storage device 231, if necessary.

The client 230 has the writer (removable media reader/writer 180) that can write the original storage location key data 212 into the original storage location key data storage device 231.

A user carries the original storage location key data storage device 231 and unlocks electronic lock with the original storage location key data storage device 231 at an original storage location 240 that is the storage location of the original document (paper document) corresponding to the electronic document. Then, the user takes out an original document 241 from the original storage location 240.

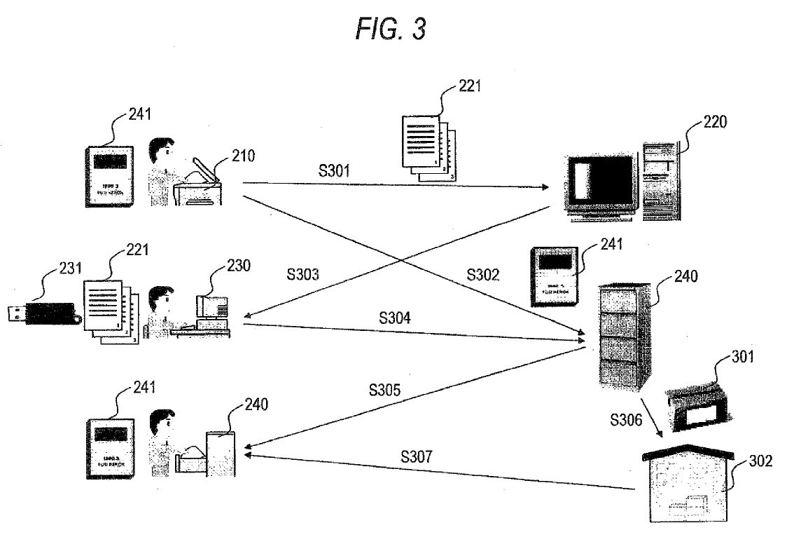

Next, an example of the function and the operation of the first exemplary embodiment will be described with reference to FIG. 3.

At step S301, a user scans a paper document serving as an original (original document 241) and registers the thus obtained electronic document (electronic document 221) in the document management server 220. Also, the user sets a storage location of the paper document as an attribute of the electronic document 221.

At step S302, the user stores the scanned original document 241 in the original storage location 240 that can be electronically locked, such as a drawer or a cabinet in a room.

At step S303, the user may access the electronic document (electronic document 221) with the client 230 based on an access right set in the document management server 220. If necessary, the user may download “key information” to take out the paper document from the original storage location 240, into a portable device (original storage location key data storage device 231) such as the USB token connected to the client 230 at hand by performing “taking out the original” operation.

At step S304, the user may unlock the electronic lock of the original storage location 240 with the original storage location key data storage device 231.

At step S305, the user may obtain the original document 241 with the key information stored in the original storage location key data storage device 231. Accordingly, availability of a paper document using an electronic document 221 can be controlled.

At step S306, in the case where the original document 241 is moved from the original storage location 240 (cabinet, etc., in a room) to a repository 302, etc. with passage of time, the original document 241 is stored in a storage box 301 whose electronic lock is set for each security setting.

At step S307, when the storage box 301 of the original document 241 transported from the repository 302 is to be unlocked by the operation of “taking out the original” from the document management server 220, the USB token is used in a similar manner.

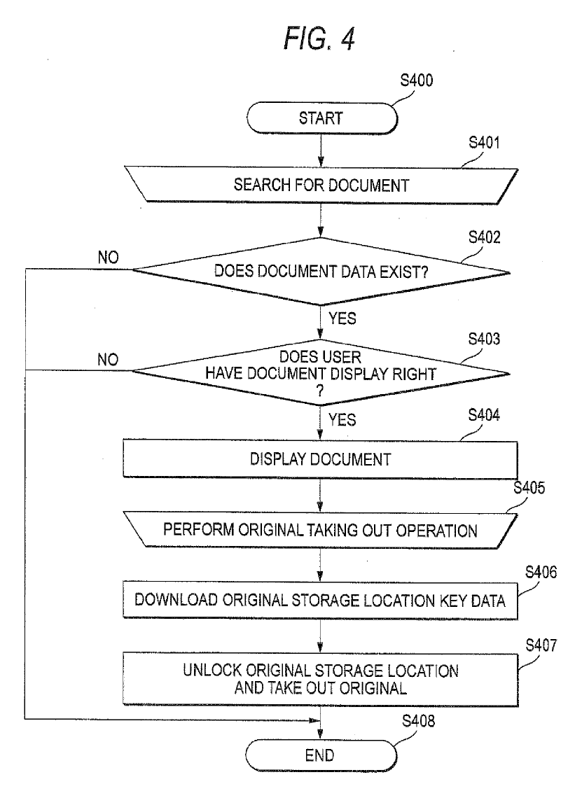

A processing example of browsing the electronic document 221 and taking out a paper document will be described with reference to a flowchart of FIG. 4.

At step S401, a user searches for the electronic document 221 in the document management server 220 from the client 230 using a keyword, etc.

At step S402, if the electronic document 221 to be found at step S401 is registered in the document management server 220, the process goes to step S403. Otherwise, the process is terminated (step S408).

At step S403, if the user has a display right for the found electronic document 221, the process goes to step S404. Otherwise, the process is terminated (step S408).

Steps S402 and S403 are executed in the document management server 220.

At step S404, the found electronic document 221 is sent from the document management server 220 to the client 230, which then displays the electronic document 221 for the user.

At step S405, if the user needs to reference the original document 241, the user performs “taking out the original” operation using the client 230. As the user performs this operation, the client 230 makes a request for acquisition of the original storage location key data 212 of the paper document corresponding to the electronic document 221.

At step S406, the original input/storage location management server 210 checks the access right for the specified electronic document 221. If the requested original storage location key data 212 exists, the original input/storage location management server 210 sends it to the client 230. The client 230 downloads the original storage location key data 212.

At step S407, the downloaded original storage location key data 212 is stored in the original storage location key data storage device 231. The user carries the original storage location key data storage device 231 to the original storage location 240. Then, the user unlocks the original storage location 240 and takes out the original document 241.

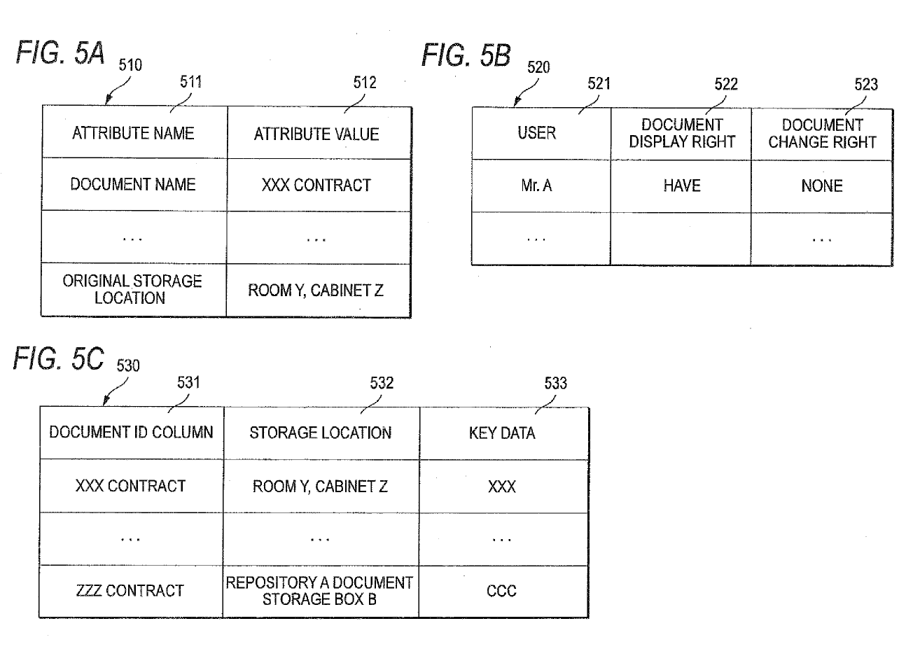

Examples of data used in the first exemplary embodiment will be described with reference to FIG. 5.

FIG. 5A shows an example of a document attribute table 510 for storing attributes of each electronic document 221 managed by the document management server 220. The document attribute table 510 is set for each electronic document 221. The document attribute table 510 contains an attribute name column 511 and an attribute value column 512. An example of the attribute name is a “document name” (that may be used as a document identifier) and an “original storage location” where the paper document corresponding to the electronic document 221 is stored.

FIG. 5B shows an example of a document access right table 520 for storing an access right for each electronic document 221 managed by the document management server 220. The document access right table 520 is set for each electronic document 221. The document access right table 520 contains a user column 521, a document display right column 522, and a document change right column 523. The user column 521 stores a user identifier (user ID) for uniquely identifying each user. The document display right column 522 stores whether or not displaying of the electronic document 221 is permitted. The document change right column 523 stores whether or not editing of the electronic document 221 is permitted.

The document management server 220 controls access to the electronic document 221 using the document access right table 520. The original input/storage location management server 210 permits downloading of the original storage location key data 212 in conjunction with permission of the document display right.

FIG. 5C shows an example of an original storage location key data table 530 for storing each original storage location key data 212 managed by the original input/storage location management server 210. The original storage location key data table 530 contains a document ID column 531, a storage location column 532 and a key data column 533. The document ID column 531 stores a document ID for uniquely identifying each electronic document 221 (or paper document). The storage location column 532 stores a storage location of a paper document corresponding to each electronic document 221. The key data column 533 stores key data to unlock the electronic lock of the storage location.

The key data may be key data to unlock the electronic lock or may be seed data to generate the key data. If seed data is used, the original input/storage location management server 210 or the client 230 generates the key data based on the seed data.

To improve the security level, expiration date of the key data and number of times the key data can be used may be set. The expiration date of the key data and the number of times the key data can be used are determined each time the key data is downloaded to the storage device 231. They are dynamically determined in such a manner that the expiration date may be set to be within three days from the download date, for example. The expiration date of the key data and the number of times the key data can be used are stored in the original storage location key data storage device 231 or in the electronic lock of the original storage location 240. The expiration date is used so that it is made impossible to unlock the electronic lock if the expiration date is exceeded. To use the number of times the key data can be used, whenever the key data is used, count is decremented, and when the count reaches 0, it is made impossible to unlock the electronic lock with the key data.

The original storage location key data table 530 may be provided with columns that store the expiration date of the key data and the number of times the key data can be used, respectively. Further, the expiration date of the key data and the number of times the key data can be used may be stored in any table other than the original storage location key data table 530.

In the exemplary embodiment described above, the original input/storage location management server 210 and the document management server 220 are shown as the separate systems, but may be integrated into one system.

In the exemplary embodiment described above, if a user has a display right as the access right for the electronic document 221, the key data to unlock the storage location of the paper document can be downloaded. However a new access right may be set as a right for taking out the original.

To prevent the user from losing or confusing the storage location of the paper document, when the paper document is scanned, the document management server 220 may present the storage location of the paper document (for example, a file “B” of a cabinet “A”) to the user based on the access control to the electronic document 221.

Only a paper document permitted to be accessed or only a file storing the paper document permitted to be accessed may be automatically ejected from the cabinet rather than unlocking of the whole cabinet, for example, using the original storage location key data storage device 231.

The paper document or the electronic document 221 may be made up of two or more pages.

For the document attribute table 510, the document access right table 520, and the original storage location key data table 530, the table structure is shown as the data structure. However, the data structure is not limited thereto, and a link structure, etc., may be adopted as the data structure.

A second exemplary embodiment provides a system that can manage key information for accessing an electronic document 221.

In the first exemplary embodiment, the electronic document 221 and the key information relating to the storage location of the paper document corresponding to the electronic document 221 are stored in association with each other. The key information is used to unlock the electronic lock of the storage location. In the second exemplary embodiment, the key information is used as key information for accessing the electronic document 221. Parts identical with those of the first exemplary embodiment are denoted by the same reference numerals in the second exemplary embodiment and duplicate description will not be given.

That is, a key information storage module 150 stores a document ID for uniquely identifying each electronic document 221 and key information for accessing each electronic document 221 in association with each other.

A reception module 110 receives a request for acquisition of key information corresponding to a specified electronic document 221.

A key information detection module 120 detects the requested key information stored in the key information storage module 150 in response to the request received by the reception module 110.

Next, processing in the second exemplary embodiment, that is, processing of downloading “key information” to open the electronic document 221 and storing the key information in a portable recording medium, for example, a USB token will be described.
(1) “Encryption downloading” of the electronic document 221 stored in a document management server 220 (in this case, the electronic document 221 may be not only the electronic document 221 of an image scanned through an image input module 145, but also the electronic document 221 mainly including text generated by a document creation application software, etc.,) is executed. The “encryption downloading” is to encrypt the electronic document 221 before transfer when the document management server 220 transfers the electronic document 221 to a client 230. The encrypted document can be decrypted with key information. After sending the encrypted electronic document, the document management server 220 sends the key information to the client 230.
(2) The client 230 downloads the encrypted electronic document sent from the document management server 220 to a disk as a usual file. The client 230 stores the key information for accessing the encrypted electronic document in the USB token, etc.
(3) The encrypted electronic document 221 cannot be opened unless the key information stored in the USB token, etc., is obtained. That is, even if the encrypted electronic document is copied or a PC (Personal Computer) storing the encrypted electronic document is stolen, the encrypted electronic document cannot be decrypted to open the document unless the key information in the USB token, etc., is obtained.

In the second exemplary embodiment, as an access right, a copy right for determining whether or not copying of the electronic document 221 is permitted, a print right for determining whether or not printing of the electronic document 221 is permitted, etc., may be provided to perform detailed access control. If an attempt is made to perform one processing for the electronic document 221, whether or not key information to execute the action is stored in the recording medium is checked. If the key information is included, the processing is allowed. For example, if an attempt is made to copy the electronic document 221, the key information in the USB token, etc., is checked. The electronic document 221 may be copied if the key information is included.

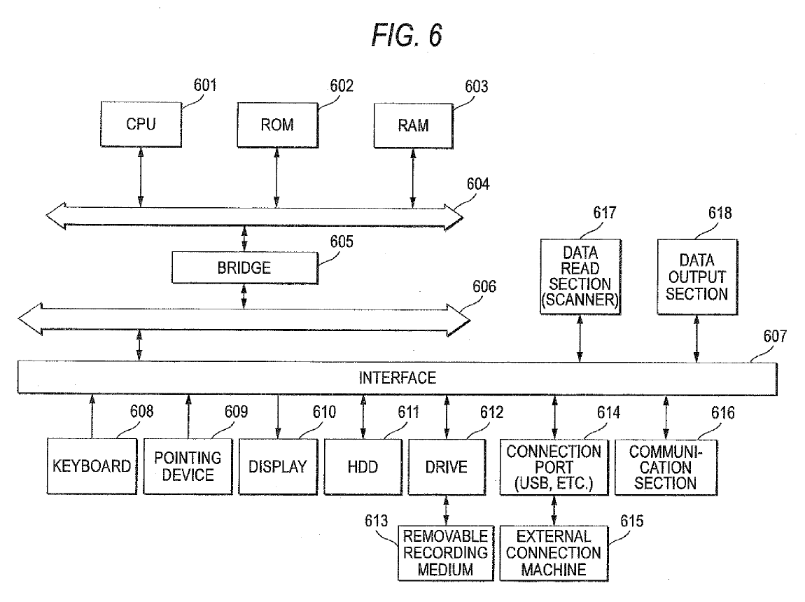

A hardware configuration example to implement the first and second exemplary embodiments will be described with reference to FIG. 6. The configuration shown in FIG. 6 is implemented as a personal computer (PC), etc., for example, and shows a hardware configuration example including a data read section 617 such as a scanner and a data output section 618 such as a printer.

A CPU (Central Processing Unit) 601 is a control section for executing processing conforming to a computer program describing the execution sequence of the various modules described above in the exemplary embodiments, namely, the modules of the key information detection module 120, the access right check module 130, etc.

ROM (Read-Only Memory) 602 stores programs, operation parameters, etc., used by the CPU 601. RAM (Random Access Memory) 603 stores programs used in execution of the CPU 601, parameters changing appropriately in the execution of the CPU 601, and the like. They are connected by a host bus 604 implemented as a CPU bus, etc.

The host bus 604 is connected to an external bus 606 such as a PCI (Peripheral Component Interconnect/Interface) bus, for example, through a bridge 605.

A keyboard 608 and a pointing device 609 such as a mouse are input devices operated by the operator. A display 610 is implemented as a liquid crystal display, a CRT (Cathode Ray Tube), or the like for displaying various pieces of information as text and image information.

An HDD (Hard Disk Drive) 611 contains a hard disk and drives the hard disk for recording or playing back a program and information executed by the CPU 601. The hard disk stores the electronic document 221, the key information, etc. It further stores various data processing programs, various computer programs, etc.

A drive 612 reads data or a program recorded on a mounted removable recording medium 613 such as a magnetic disk, an optical disk, a magneto-optical disk, or semiconductor memory, and supplies the data or the program to the RAM 603 connected through the interface 607, the external bus 606, the bridge 605, and the host bus 604. The removable recording medium 613 can also be used as a data record area like a hard disk.

A connection port 614 is a port for connecting an external connection machine 615 and has a connection section of a USB, IEEE 1394, etc., for example. The connection port 614 is connected to the CPU 601, etc., through the interface 607, the external bus 606, the bridge 605, the host bus 604, etc. A communication section 616 is a network interface card (NIC), for example, and is connected to a network for executing data communication processing with an external system. A data read section 617 is a scanner, for example, and executes document read processing. A data output section 618 is a printer, for example, and executes document data output processing.

The hardware configuration shown in FIG. 6 shows one configuration example and the exemplary embodiments are not limited to the configuration shown in FIG. 6 and any configuration may be adopted if it makes it possible to execute the modules described in the exemplary embodiments. For example, some modules may be implemented as dedicated hardware (for example, an application-specific integrated circuit (ASIC), etc.,) and some modules may be included in an external system and may be connected via a communication line and further a plurality of systems shown in FIG. 6 may be connected via a communication line so as to operate in cooperation with each other. The system may be built in a copier, a fax, a scanner, a printer, a multifunction processing machine (also called a multifunction copier, having the functions of a scanner, a printer, a copier, a fax, etc.,), etc.

The program described above may be stored on a recording medium for distribution or may be provided through communication means. In this case, for example, the program described above may be grasped as invention of “computer-readable recording medium recording a program.” The expression “computer-readable recording medium recording a program” is used to mean a recording medium read by a computer recording a program, used to install and execute a program, to distribute a program, etc.

The record media include “DVD-R, DVD-RW, DVD-RAM, etc.,” of digital versatile disk (DVD) and standard laid down in DVD Forum, “DVD+R, DVD+RW, etc.,” of standard laid down in DVD+RW, read-only memory (CD-ROM), CD recordable (CD-R), CD rewritable (CD-RW), etc., of compact disk (CD), magneto-optical disk, flexible disk (FD), magnetic tape, hard disk, read-only memory (ROM), electrically erasable and programmable read-only memory (EEPROM), flash memory, random access memory (RAM), etc., for example.

The described program or a part thereof may be recorded in any of the described record media for retention, distribution, etc. The described program or a part thereof may be transmitted by communications using a transmission medium such as a wired network used with a local area network, a metropolitan area network (MAN), a wide area network (WAN), the Internet, an intranet, an extranet, etc., or a wireless communication network or a combination thereof, etc., for example, and may be carried over a carrier wave.

Further, the described program may be a part of another program or may be recorded in a recording medium together with a different program. The program may be divided into pieces to be recorded on a plurality of record media. It may be recorded in any mode such as compression or encryption if the program can be decompressed or decrypted.

What is claimed is:

1. A computer readable medium storing a program causing a computer to execute electronic document processing, the electronic document processing comprising:
storing, in a storage section, (i) a document identifier for uniquely identify each electronic document and (ii) key information of a storage of a non-electronic document which relates to each electronic document, in association with each other;
receiving a request for acquisition of key information which is associated with a specified electronic document; and
detecting the requested key information stored in the storage section in response to the received request.

2. The medium according to claim 1, wherein:
the key information is information to unlock an electronic lock provided with a storage device in which the non-electronic document is stored.

3. The medium according to claim 1, wherein:
an access right is set for each electronic document, and
if a requesting party who makes the request does not have the access right for the electronic document, the detecting controls so as not to output the detected key information to the requesting party.

4. The medium according to claim 1, wherein:
an access right is set for the electronic document, and
if a requesting party who makes the request has the access right for the electronic document, the detecting controls so as to output the detected key information to the requesting party.

5. The medium according to claim 1, wherein:
the storage section further stores information about location of a storage device in which the non-electronic documents are stored, and
the electronic document processing further comprises notifying the information about location of a storage device in which the non-electronic document which relates to the specified electronic document is stored, to a requesting party who makes the request.

6. A computer readable medium storing a program causing a second computer to execute a process of recording key information, the second computer connected, via communication means, to a first computer that has read the program according to claim 1, the process of recording the key information comprising:
transmitting a request for acquisition of the key information to the first computer;
receiving the key information corresponding to the transmitted request; and
recording the received key information in a portable recording medium.

7. An electronic document processing system comprising:
a storage control section that stores, in a storage section, (i) a document identifier for uniquely identify each electronic document and (ii) key information of a storage of a non-electronic document which relates to each electronic document, in association with each other;
a reception section that receives a request for acquisition of key information which is associated with a specified electronic document; and
a detection section that detects the requested key information stored in the storage section in response to the received request.

8. The system according to claim 7, wherein
the key information is information to unlock an electronic lock provided with a storage device in which the non-electronic document is stored.

9. The system according to claim 7, wherein:
an access right is set for each electronic document, and
if a requesting party who makes the received request does not have the access right for the electronic document, the detection section does not output the detected key information to the requesting party.

10. The system according to claim 7, wherein:
an access right is set for the electronic document, and
if a requesting party who makes the received request has the access right for the electronic document, the detection section outputs the detected key information to the requesting party.

11. The system according to claim 7, wherein:
the storage section further stores information about location of a storage device in which the non-electronic documents are stored, and
the system further comprises a notification section that notifies the information about location of a storage device in which the non-electronic document which relates to the specified electronic document is stored, to a requesting party who makes the received request.

12. A key information recording system comprising:
a communication section that communicates with the electronic document processing system according to claim 7;
a request transmission section that transmits the request for acquisition of the key information to the electronic document processing system;
a key information reception section that receives the key information corresponding to the transmitted request; and
a medium recording section that records the received key information received into a portable recording medium.

13. A document storage system comprising:
the electronic document processing system according to claim 7;
the key information recording system according to claim 12; and
a non-electronic document storage apparatus comprising
a locking section that locks a storage device in which the non-electronic document relating to the specified electronic document is stored, so that the locking can be unlocked based on specific key information;
a medium reading section that reads the recording medium; and
an unlocking section that unlocks the storage device locked by the locking section when key information read from the recording medium by the medium reading section is identical with the specific key information.

14. An electronic document processing method comprising:
storing, in a storage section, (i) a document identifier for uniquely identify each electronic document and (ii) key information of a storage of a non-electronic document which relates to each electronic document, in association with each other;
receiving a request for acquisition of key information which is associated with a specified electronic document; and
detecting the requested key information stored in the storage section in response to the received request.

15. A computer data signal embodied in a carrier wave for enabling a computer to perform electronic document processing, the electronic document processing comprising:
storing, in a storage section, (i) a document identifier for uniquely identify each electronic document and (ii) key information of a storage of a non-electronic document which relates to each electronic document, in association with each other;
receiving a request for acquisition of key information which is associated with a specified electronic document; and
detecting the requested key information stored in the storage section in response to the received request.
